(19) United States
(12) Patent Application Publication
(10) Pub. No.: US 2022/0273129 A1
(43) Pub. Date: Sep. 1, 2022

(54) Flexible Pour-over Filter Apparatus

(71) Applicant: Elliot Lamm, Brooklyn, NY (US)

(72) Inventor: Elliot Lamm, Brooklyn, NY (US)

(21) Appl. No.: 17/337,782

(22) Filed: Jun. 3, 2021

Related U.S. Application Data
(63) Continuation-in-part of application No. 17/189,047, filed on Mar. 1, 2021.

(51) Int. Cl. A47J 31/02; A47J 31/08

(52) U.S. Cl. CPC A47J 31/02; A47J 31/08; A47J 2203/00

(57) ABSTRACT

The present disclosure provides a pour-over filter apparatus which is comprised of a cone-shaped filter holder portion and a base and support portion. The base and support portion is provided with openings which serve as viewing windows to allow a user to view a liquid level in a container underneath the base, and the entire apparatus is made of a flexible material such as silicone to facilitate folding and bending to make it portable and packable. The flexible nature of the material enables the cone of the filter to fold over on itself for a more compact configuration of the filter for storage purposes.

### CROSS REFERENCES TO RELATED APPLICATIONS

The present application claims the benefit and priority of U.S. application Ser. No. 17/189,047, filed Mar. 1, 2021.

### FIELD OF INVENTION

The present invention relates generally to the field of brewing and filtering apparatus. More specifically, the present invention relates to a pour over brewer for making hot drinks such as coffee using filter paper.

### BACKGROUND

Pour-over coffee filters/brewers are well known in the art. They consist of a cone shaped portion and a base, the cone shaped portion having small holes to allow the passage of liquid that has been filtered by a paper cone resting therein, such that when the base is rested on the lip of a container such as a mug or thermos, the filtered liquid falls into the container. Such apparatus are commonly used to brew hot drinks such as coffee by pouring coffee grounds into a paper filter held in the cone and pouring hot water over the coffee filter.

One problem that arises with this brewing technique is that a user often misjudges how much liquid should be poured over the grounds before the container is full. As the user has no way of checking the liquid level within the container, this often leads to too much liquid being poured in and results in overflow and spillage from the container.

Additionally, although functional, the design of the conventional pour-over filter is not space-efficient, making them awkward to carry on one's person. It would be desirable for a more portable filter design to be made available.

It is within this context that the present invention is provided.

### SUMMARY

The present disclosure provides a pour-over filter apparatus which is comprised of a cone-shaped filter holder portion and a base and support portion. The base and support portion is provided with openings which serve as viewing windows to allow a user to view a liquid level in a container underneath the base, and the entire apparatus is made of a flexible material such as silicone to facilitate folding and bending to make it portable and packable. The flexible nature of the material enables the cone of the filter to fold over on itself for a more compact configuration of the filter for storage purposes.

Thus, according to one aspect of the present disclosure there is provided a flexible pour-over filter apparatus, comprising: a cone-shaped filter holder portion having an inner conical surface configured to receive a paper filter, wherein a point of the conical inner surface ends in one or more small openings for allowing liquid to pass through.

The apparatus further comprises a planar base and support portion joined to an outer surface of the point of the cone-shaped filter holder portion and configured to support the filter holder portion by resting against the lip of a cup, thermos, or other container, wherein the planar base and support portion is provided with two or more viewing window openings for allowing a user to view a liquid level in a container on which the apparatus is resting.

Both the cone-shaped filter and planar base and support portions are made of a flexible material. In some embodiments, the flexible material is silicone.

In some embodiments, an inner surface of the cone-shaped filter holder portion is provided with one or more linear grip elements to prevent a paper filter held therein from sliding against the inner surface.

In some embodiments, the cone-shaped filter holder portion is configured to receive a size two paper (Hario or Melitta style) filter.

In yet further embodiments, the cone-shaped filter holder portion is configured to move between an unfolded position and a folded position where the lip of the cone folds over itself to rest closer to the planar base.

### BRIEF DESCRIPTION OF THE DRAWINGS

Various embodiments of the invention are disclosed in the following detailed description and accompanying drawings.

FIG. 1 illustrates an example configuration of the filter apparatus of the present disclosure in perspective view.

FIG. 2 illustrates the example configuration of the apparatus of FIG. 1 in use, with a paper coffee filter fitted therein and resting atop a mug container.

FIG. 3 illustrates the example configuration of the apparatus of FIG. 1 in a folded position for storage purposes.

FIG. 4 illustrates a side-on view of a folding operation of the example configuration of the apparatus of FIG. 1.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure relates to a flexible coffee pour over brewer configured to receive a paper filter for brewing coffee.

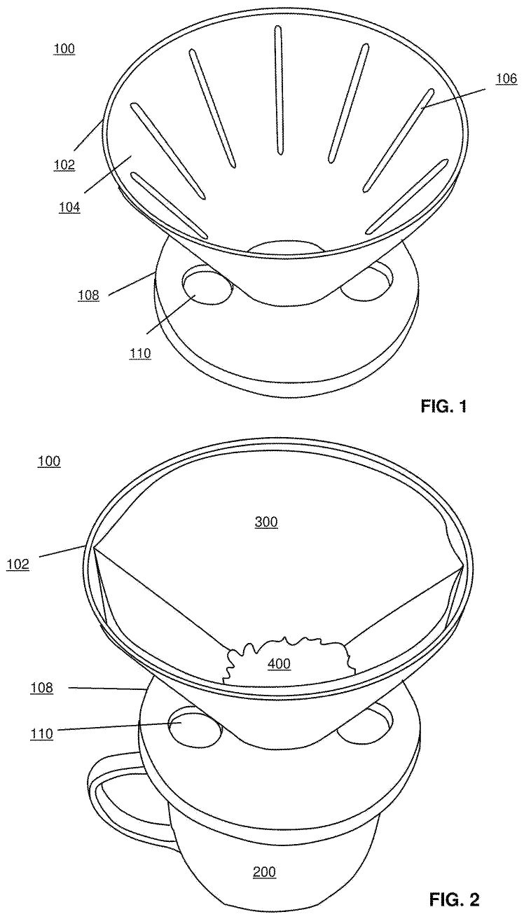

Referring to FIG. 1 an example configuration of the device 100 is shown in perspective view.

As can be seen the apparatus 100 comprises a cone-shaped filter holder portion 102 having an inner conical surface 104 configured to receive a paper filter. The endpoint of the conical inner surface ends in one or more small openings (not shown) for allowing liquid to pass through once it has been filtered through for example a paper coffee filter. The apparatus may be specifically shaped and dimensioned to receive a size two paper (Hario or Melitta style) filter.

The inner surface 104 of the cone-shaped filter holder portion 102 is provided with one or more linear grip elements 106 to prevent a paper filter held therein from sliding about against the inner surface.

A planar base and support portion joined 108 is attached to an outer surface of the point of the cone-shaped filter holder portion 102 and configured to support the filter holder portion by resting against the lip of a cup, thermos, or other container. This planar base and support portion is provided with two or more viewing window openings 110 for allowing a user to view a liquid level in a container on which the apparatus is resting.

Both the cone-shaped filter and planar base and support portions are made of a flexible material to allow the device to be folded up and easily transported.

Silicone is particularly advantageous because it also provides good grip for holding both the filter paper and lip of a container on which the apparatus is placed, whilst also being both durable and flexible. In one example the apparatus is made of a single piece of silicone.

Referring to FIG. 2, the apparatus 100 can be seen in use on a mug 200. Other types of containers could also be used here as the apparatus is compatible with various sized tumblers, thermoses and cups including those with narrow openings. A paper filter 300 and coffee grounds 400 are also shown held within the cone-shaped filter holder portion ready for a liquid to be poured over.

The apparatus 100 would be highly durable, shatterproof and portable. It would be flexible and yet retain its original shape vs hard or very soft material which would either break or lose its shape.

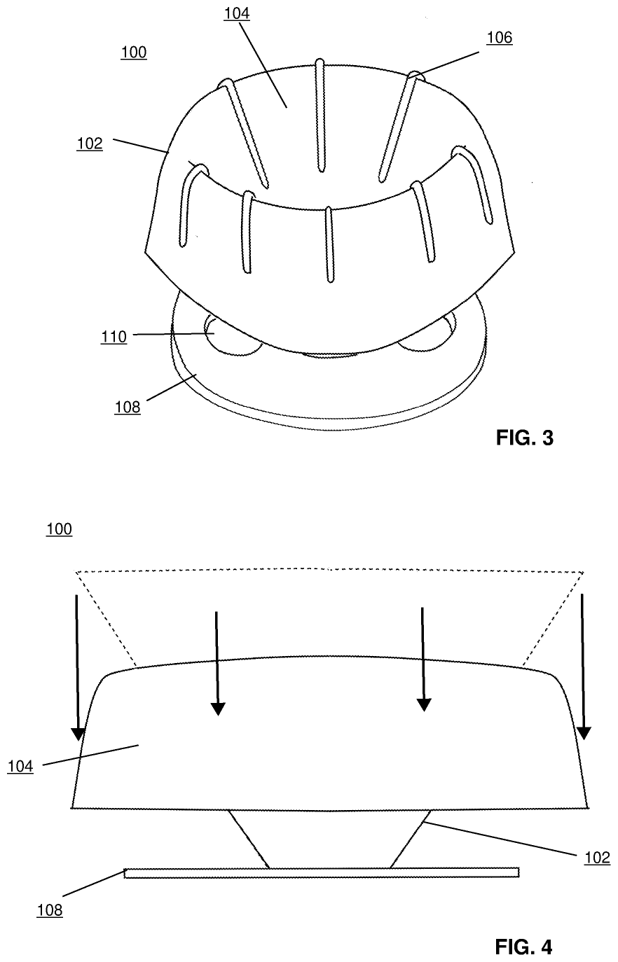

Referring to FIG. 3, the same example configuration of the apparatus 100 is shown, whereby the flexible nature of the material from which the filter holder 102 has been utilized by folding the lip of the cone outwards and downwards towards the base portion 108.

This capability of the disclosed apparatus significantly increases portability, allowing the apparatus 100 to take on a more compact form when it is to be stored, for example in a travel bag or rucksack.

Referring to FIG. 4, a side on view of the folding operation of the apparatus 100 is shown, with the initial unfolded configuration shown by the dashed line. As can be seen, the inversal of the cone 102 significantly reduces the overall height of the apparatus 100, and hence also reduces the volume it occupies. Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the coffee filter apparatus have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A flexible pour-over filter apparatus, comprising:
a cone-shaped filter holder portion having an inner conical surface configured to receive a paper filter, wherein a point of the conical inner surface ends in one or more small openings for allowing liquid to pass through; and
a planar base and support portion joined to an outer surface of the point of the cone-shaped filter holder portion and configured to support the filter holder portion by resting against the lip of a cup, thermos, or other container, wherein the planar base and support portion is provided with two or more viewing window openings for allowing a user to view a liquid level in a container on which the apparatus is resting;
wherein both the cone-shaped filter and planar base and support portions are made of a flexible material.

2. A flexible pour-over filter apparatus according to claim 1, wherein the flexible material is silicone.

3. A flexible pour-over filter apparatus according to claim 1, wherein an inner surface of the cone-shaped filter holder portion is provided with one or more linear grip elements to prevent a paper filter held therein from sliding against the inner surface.

4. A flexible pour-over filter apparatus according to claim 1, wherein the cone-shaped filter holder portion is configured to receive a size two paper (Hario or Melitta style) filter.

5. A flexible pour-over filter apparatus according to claim 1, wherein the cone-shaped filter holder portion is configured to move between an unfolded position and a folded position where the lip of the cone folds over itself to rest closer to the planar base.
